(19) United States
(12) Patent Application Publication
(10) Pub. No.: US 2021/0308985 A1
(43) Pub. Date: Oct. 7, 2021

(54) SEALANT FILM, LAYERED FILM, AND PACKAGING MATERIAL

(71) Applicant: DIC Corporation, Tokyo (JP)

(72) Inventors: Yuki KABURAGI, Saitama (JP); Daiki TOKIEDA, Saitama (JP); Takashi MORIYA, Saitama (JP)

(73) Assignee: DIC Corporation, Tokyo (JP)

(21) Appl. No.: 17/266,987

(22) PCT Filed: Aug. 8, 2019
(86) PCT No.: PCT/JP2019/031359

§ 371 Date: Feb. 8, 2021

(30) Foreign Application Priority Data
Aug. 23, 2018 (JP) 2018-156376

(51) Int. Cl. B32B 7/027; B32B 27/30; B32B 27/08; B32B 27/32

(52) U.S. Cl. CPC B32B 7/027; B32B 27/306; B32B 27/308; B32B 27/08; B32B 2307/50; B32B 2307/31; B32B 2307/732; B32B 2439/00; B32B 27/32

(57) ABSTRACT

A sealant film including a layered film that includes a sealable resin layer including a heat seal layer (A) as a surface layer; and a base material layer (B), in which the sealable resin layer is formed of a resin layer having a 1% secant modulus of 200 MPa or less and has a thickness of 15 μm to 50 μm, the heat seal layer (A) has a 1% secant modulus of 20 MPa to 45 MPa and a thickness of 5 μm or more, and the base material layer (B) has a 1% secant modulus of 250 MPa or more and a thickness of 1 μm to 30 μm. Thus, the sealant film not only has good adhesion and suitable openability with respect to the surface to be adhered to but also achieves excellent pressure resistance that prevents the occurrence of opening even under high-pressure treatment.

### TECHNICAL FIELD

The present invention relates to a sealant film and a layered film that, with respect to an adherend such as a heat sealed portion of a packaging container, have good adhesion and are capable of achieving easy-openability that enables suitable peelability.

### BACKGROUND ART

Recently, in medical equipment packages and food packaging, amid the trend towards universal design, in consideration of the socially vulnerable (e.g., the elderly, young children, and the disabled) emphasis has been placed on techniques that facilitate consumers to open such packages and packaging, for example, on easy-openability. Among them, particular emphasis has been placed on lid materials having easy-openability that are used for, for example, containers.

PTL 1 discloses, as a layered film having easy-openability, a layered film in which a heat seal layer containing an ethylene-vinyl acetate copolymer and/or an ethylene-methyl methacrylate copolymer and a laminate layer containing an ethylene resin having a low melt flow rate (MFR) are layered. Due to the structure, this layered film exhibits excellent easy-openability regardless of the sealing temperature.

### CITATION LIST

### Patent Literature

PTL 1: Japanese Unexamined Patent Application Publication No. 2015-063072

### SUMMARY OF INVENTION

### Technical Problem

Easy-peel films having easy-openability are used in packaging materials for, for example, medical equipment and foods, and in these applications, usually, sterilization is performed on the contents. In an existing sterilization step, sterilization at a high temperature is widely used, but recently, high pressure treatment in which sterilization is performed at a high pressure of 200 MPa or more has been used due to its capability of preventing or reducing the deterioration of the contents and enabling energy saving. Thus, it has been desired that easy-peel films having easy-openability have not only good openability but also enhanced pressure resistance that prevents the occurrence of opening or burst even under high-pressure treatment.

The present invention has an object to provide a sealant film and a layered film that have not only good adhesion and suitable openability with respect to the surface to be adhered to but also excellent pressure resistance that prevents the occurrence of opening even under high-pressure treatment.

### Solution to Problem

The present invention achieves the object with a sealant film including a layered film that includes a sealable resin layer including a heat seal layer (A) as a surface layer; and a base material layer (B), in which the sealable resin layer is formed of a resin layer having a 1% secant modulus of 200 MPa or less and has a thickness of 15 μm to 50 μm, the heat seal layer (A) has a 1% secant modulus of 20 MPa to 45 MPa and a thickness of 5 μm or more, and the base material layer (B) has a 1% secant modulus of 250 MPa or more and a thickness of 1 μm to 30 μm.

### Advantageous Effects of Invention

The sealant film according to the present invention has not only good adhesion and suitable easy-openability with respect to various adherends such as PP, PE, A-PET, and C-PET but also suitable pressure resistance that prevents the occurrence of opening or burst even under high-pressure treatment, and thus can be suitably used in applications to packaging materials for, for example, medical equipment and foods on which high-pressure treatment for sterilization is performed.

### DESCRIPTION OF EMBODIMENTS

Hereafter, each portion forming a sealant film and a laminate film according to the present invention will be described in detail.

The sealant film according to the present invention includes a layered film that includes a sealable resin layer including a heat seal layer (A) as a surface layer; and a base material layer (B), in which the sealable resin layer is formed of a resin layer having a 1% secant modulus of 200 MPa or less and has a thickness of 15 μm to 50 μm, the heat seal layer (A) has a 1% secant modulus of 20 MPa to 45 MPa and a thickness of 5 μm or more, and the base material layer (B) has a 1% secant modulus of 250 MPa or more and a thickness of 1 μm to 30 μm.

### [Sealable Resin Layer]

A sealable resin layer of the sealant film according to the present invention, the sealable resin layer including a heat seal layer (A) as a surface layer, is a resin layer having a 1% secant modulus of 200 MPa or less and has a thickness of 15 μm to 50 μm. The 1% secant modulus is preferably 15 MPa to 180 MPa and more preferably 20 MPa to 150 MPa. The thickness is preferably 18 μm to 45 μm and more preferably 20 to 40. The sealable resin layer may be a resin layer having a single-layer structure or a multilayer structure. When the sealable resin layer is within this range, because of the resin layer being soft, the sealant film has good adhesion with respect to various thermoplastic resin materials forming an adherend. When a laminate film obtained by laminating the sealant film together with, for example, an oriented base material is used as a lid material film of various containers, the sealable resin layer can follow the deformation, such as film elongation, accompanying internal pressure changes that occur during, for example, a sterilization step including heating or pressurization, thereby reducing the occurrence of peeling at the seal interface of the heat seal layer and such a container. Thus, it is possible to enhance pressure resistance that prevents or reduces the occurrence of bag breakage accompanying internal pressure changes in the container.

### [Heat Seal Layer (A)]

When a heat seal layer (A) forming a surface layer of the sealable resin layer has a 1% secant modulus of 20 MPa or more, the elongation of the sealable resin layer during opening can be prevented or reduced, thereby enabling the achievement of suitable easy-openability without causing stringing during peeing. When the heat seal layer (A) is a resin layer having a 1% secant modulus of 45 MPa or less, the adhesion with respect to an adherend and the followability to the deformation, such as elongation, of the sealable resin layer can be improved, thereby enabling the achievement of suitable pressure resistance. The 1% secant modulus of the heat seal layer (A) is preferably 25 MPa to 42 MPa and more preferably 30 MPa to 39 MPa.

When the thickness of the heat seal layer (A) is 5 μm or more, good adhesion can be achieved. The sealable resin layer as a whole may be the heat seal layer (A), and the upper limit may be 50 μm. The thickness is preferably 5 μm to 40 μm and more preferably 5 μm to 30 μm.

The heat seal layer (A) preferably has an ethylene resin as a main resin component, and relative to the resin component contained in the heat seal layer (A), preferably 50% by mass or more is an ethylene resin, more preferably 50% to 97% by mass is an ethylene resin, and even more preferably 73% to 88% by mass is an ethylene resin. As the ethylene resin, an ethylene-vinyl acetate copolymer and/or an ethylene-methyl methacrylate copolymer can be preferably used, and an ethylene-vinyl acetate copolymer resin can be particularly preferably used. The ethylene-vinyl acetate copolymer and/or the ethylene-methyl methacrylate copolymer is not particularly limited, but among them, such a copolymer resin having a vinyl acetate- and/or a methyl methacrylate-derived component content of 15% to 25% by mass is preferable, because it facilitates the adjustment of the 1% secant modulus to 20 MPa to 45 MPa and the achievement of high flexibility, thereby enabling the realization of high internal pressure resistance.

The ethylene-vinyl acetate copolymer and/or the ethylene-methyl methacrylate copolymer may be a modified product into which an unsaturated carboxylic acid, such as (meth)acrylic acid or maleic anhydride, or an anhydride thereof is introduced for the impartation of adhesion functions.

For the impartation of adhesion functions with respect to various thermoplastic resin materials forming an adherend to a resin composition for the heat seal layer (A), a tackifier resin is preferably used. Examples of the tackifier resin include aliphatic hydrocarbon resins (including alicyclic hydrocarbon resins), aromatic hydrocarbon resins, rosins, and polyterpene resins. As the tackifier resin, an aliphatic hydrocarbon resin can be preferably used in view of its excellence in, for example, low odor properties, transparency, and moldability. When the tackifier resin is used in combination, the content is preferably 3% to 30% by mass and more preferably 10% to 25% by mass relative to the resin component contained in the heat seal layer (A).

Examples of the aliphatic hydrocarbon resins include polymers having, as a main component, a monoolefin or diolefin of 4 to 5 carbon atoms such as butene-1, butadiene, isobutylene, or 1,3-pentadiene; resins obtained by polymerizing a cyclic monomer such as cyclopentadiene or a resin that has been obtained by subjecting a diene component in a spent C4 to C5 fraction to cyclic dimerization and thereafter to polymerization; and resins obtained by the ring hydrogenation of an aromatic hydrocarbon resin. Examples of the aromatic hydrocarbon resins include resins having, as a main component, a vinyl aromatic hydrocarbon such as α-methyltoluene, vinyltoluene, or indene. Examples of the rosins include rosin, polymerized rosin, rosin glycerol esters, hydrogenation products of rosin glycerol esters, polymers of rosin glycerol esters, rosin pentaerythritol esters, hydrogenation products of rosin pentaerythritol esters, and polymers of rosin pentaerythritol esters. Examples of the polyterpene resins include hydrogenated terpene resins, terpene-phenol copolymer resins, dipentene polymers, α-pinene polymers, β-pinene polymers, and α-pinene-phenol copolymer resins.

Further examples of the tackifier resin include tackifier resins other than the foregoing, such as synthetic tackifier resins, for example, acid-modified C5 petroleum resins, C5/C9 copolymer petroleum resins, xylene resins, and coumarone-indene resins.

As a preferable combination example, when an ethylene-vinyl acetate copolymer resin and a tackifier resin are used as the resin component of the heat seal layer (A), the range is preferably such that the weight ratio of these (ethylene-vinyl acetate copolymer resin/tackifier resin) is 97/3 to 70/30 in view of the excellent adhesion with respect to various thermoplastic resin materials forming an adherend and the good film-forming properties.

Furthermore, a styrene resin is preferably combined with the heat seal layer (A). Examples of the styrene resin include homopolymers of styrene; and impact-resistant styrene resins obtained by the graft-polymerization of a styrene monomer onto synthetic rubber such as butadiene rubber or styrene-butadiene rubber. Combining a styrene resin is particularly effective to an adherend formed of a styrene resin material, and the styrene resin preferably has a MFR of 1 g to 40 g/10 min and more preferably has a MFR of 5 g to 20 g/10 min in view of the excellence in molding processability. When the styrene resin is used in combination, the content is preferably 5% to 20% by mass and more preferably 8% to 17% by mass relative to the resin component contained in the heat seal layer (A).

As a preferable combination example, when an ethylene-vinyl acetate copolymer resin, a tackifier resin, and a styrene resin are used as the resin component of the heat seal layer (A), in terms of a combination ratio, the range is preferably such that the mass ratio of these (copolymer/tackifier/styrene polymer) is 50 to 92/3 to 30/5 to 20 in view of the effectiveness particularly to an adherend formed of a styrene resin material and less deterioration of transparency.

A resin component other than the foregoing may be contained in the heat seal layer (A) within the range that does not impair the advantageous effects of the present invention. As such a resin component other than the foregoing, for example, a polyolefin resin other than the foregoing can be used, and the content of the resin other than the foregoing is preferably 10% by mass or less and more preferably 5% by mass or less relative to the resin component contained in the heat seal layer (A).

Various additives may be combined with the heat seal layer (A) within the range that does not impair the advantageous effects of the present invention. As the additives, antioxidants, weathering stabilizers, antistatic agents, antifogging agents, antiblocking agents, lubricants, nucleators, pigments, and the like can be exemplified.

### [Middle Layer (C1)]

The sealable resin layer used in the present invention may be a layer including only the heat seal layer (A), but other than this, a middle layer may be layered. When a middle layer is layered, the 1% secant modulus of the sealable resin layer as a whole is 200 MPa or less, the sealable resin layer including a plurality of layers being layered, and the thickness of the sealable resin layer as a whole is 15 μm to 50 μm. When the sealable resin layer includes a plurality of layers, the 1% secant modulus of the sealable resin layer as a whole refers to the 1% secant modulus at 23° C. measured under the conditions in accordance with ASTM D882 on a film obtained by performing layering with the same composition and the same layer proportion as with the sealable resin layer. As the layer structure of the sealable resin layer, specifically, a double-layer structure of (A)/(C1) in which the heat seal layer (A) and a middle layer (C1) are layered or a triple-layer structure of (A)/(C2)/(C1) in which the heat seal layer (A), a middle layer (C2), and the middle layer (C1) are layered can be preferably exemplified.

The 1% secant modulus of the middle layer (C1) disposed on a base material layer (B)-side surface layer of the sealable resin layer is preferably 50 MPa to 150 MPa and more preferably 60 MPa to 120 MPa. When the middle layer (C1) is used, compared with when the sealable resin layer includes only the heat seal layer (A), the enhancement of the stiffness of the sealant film is facilitated, thereby facilitating the achievement of good adhesion. Furthermore, when the middle layer (C1) is disposed, design changes of the sealant film according to the usage are facilitated. For example, when a low-priced resin is used for the middle layer (C1), suitable characteristics are achieved while reducing the cost of the sealant film as a whole.

As the resin contained in the middle layer (C1), an ethylene resin is preferably a main resin component, and relative to the resin component contained in the middle layer (C1), preferably 50% by mass or more is an ethylene resin, more preferably 60% to 100% by mass is an ethylene resin, and even more preferably 75% to 100% by mass is an ethylene resin. Examples of the ethylene resin include low-density polyethylene, medium-density polyethylene, high-density polyethylene, and linear low-density polyethylene. Among these, ethylene resins having a density of 0.860 g to 0.945 g/cm³ are preferable because they facilitate the adjustment of the 1% secant modulus of the middle layer (C1) to 50 MPa to 150 MPa. Among them, linear low-density polyethylene having a density of 0.880 g to 0.925 g/cm² capable of enabling the achievement of high flexibility and realizing high internal pressure resistance is more preferable. When such an ethylene resin having high flexibility is used, while preventing or reducing the deterioration of pressure resistance, it is possible to reduce the thickness of the heat seal layer (A) and the middle layer (C2) containing an ethylene-vinyl acetate copolymer and/or an ethylene-methyl methacrylate copolymer which is mentioned as a resin composition for the heat seal layer (A) and the middle layer (C2) and is high-priced. Accordingly, the amount of such a high-priced resin used can be reduced and thus it is possible to enhance economy.

A resin component other than the foregoing may be contained in the middle layer (C1) within the range that does not impair the advantageous effects of the present invention. As such a resin component other than the foregoing, for example, a polyolefin resin other than the foregoing can be used, and the content of the resin other than the foregoing is preferably 10% by mass or less and more preferably 5% by mass or less relative to the resin component contained in the middle layer (C1).

### [Middle Layer (C2)]

In the sealable resin layer, a middle layer (C2) preferably having a 1% secant modulus of 20 MPa to 60 MPa and more preferably having a 1% modulus of 20 to 45 may be disposed between the heat seal layer (A) and the middle layer (C1). When the middle layer (C2) is disposed, compared with when the sealable resin layer includes only the heat seal layer (A) contributing to the sealability to an adherend and the middle layer (C1) contributing to the stiffness of the sealant film, the adjustment of the followability to the deformation, such as elongation, of the sealable resin layer required for the enhancement of pressure resistance is improved, thereby enabling the achievement of suitable pressure resistance. Thus, design changes of the sealant film according to the usage are facilitated.

As the resin contained in the middle layer (C2), an ethylene resin is preferably a main resin component, and relative to the resin component contained in the middle layer (C2), preferably 50% by mass or more is an ethylene resin, more preferably 60% to 100% by mass is an ethylene resin, and even more preferably 75% to 97% by mass is an ethylene resin. As the ethylene resin, a resin composition containing an ethylene-vinyl acetate copolymer and/or an ethylene-methyl methacrylate copolymer which is mentioned for the case of the heat seal layer (A) can be used. Furthermore, for example, low-density polyethylene, medium-density polyethylene, high-density polyethylene, or linear low-density polyethylene can be used. The ethylene resin contained in the middle layer (C2) is not particularly limited, but an ethylene-vinyl acetate copolymer and/or an ethylene-methyl methacrylate copolymer is preferable, and among them, such a copolymer resin having a vinyl acetate- and/or a methyl methacrylate-derived component content of 15% to 25% by mass is preferable, because it facilitates the adjustment of the 1% secant modulus to 20 MPa to 45 MPa and the achievement of high flexibility, thereby enabling the realization of high internal pressure resistance.

The low-density polyethylene, the medium-density polyethylene, the high-density polyethylene, and the linear low-density polyethylene can be used without particular limitations, but ethylene resins having a density of 0.860 g to 0.945 g/cm³ are preferable, and among them, linear low-density polyethylene having a density of 0.880 g to 0.925 g/cm² capable of enabling the achievement of high flexibility and realizing high internal pressure resistance is more preferable.

When a resin composition in which an ethylene-vinyl acetate copolymer and/or or/or an ethylene-methyl methacrylate copolymer is mixed with low-density polyethylene, medium-density polyethylene, high-density polyethylene, or linear low-density polyethylene is used for the middle layer (C2), while preventing or reducing the deterioration of pressure resistance, it is possible to reduce the amount of resin used, the resin being such as an ethylene-vinyl acetate copolymer and/or an ethylene-methyl methacrylate copolymer which is high-priced. Thus, it is possible to enhance economy.

The thickness of the middle layer (C2) is preferably 5 μm to 20 μm and more preferably 7 to 18.

Furthermore, for the middle layer (C2), a tackifier resin is preferably used in combination with the ethylene resin. Particularly when the tackifier resin is used for the heat seal layer (A), the transition of the tackifier resin from the heat seal layer (A) to the middle layer (C2) can be prevented or reduced, thereby facilitating suitable adhesion with respect to an adherend to be retained. Accordingly, this is preferable.

As the tackifier resin used, the same tackifier resins as exemplified for the case of the heat seal layer (A) can be used and preferable tackifier resins are also the same. When a tackifier is used in combination, the content is preferably 3% to 30% by mass and more preferably 10% to 25% by mass relative to the resin component contained in the (C2).

A resin component other than the foregoing may be contained in the middle layer (C2) within the range that does not impair the advantageous effects of the present invention. As such a resin component other than the foregoing, for example, a polyolefin resin other than the foregoing can be used, and the content of the resin other than the foregoing is preferably 10% by mass or less and more preferably 5% by mass or less relative to the resin component contained in the middle layer (C2).

### [Base Material Layer (B)]

The sealant film according to the present invention, in addition to the sealable resin layer including the heat seal layer (A) as a surface layer, includes a resin layer of which a base material layer (B) has a 1% secant modulus of 250 MPa and a thickness of 1 μm to 30 μm. When the base material layer (B) is within this range, the shortage of the mechanical strength of a layered film due to the soft sealable resin layer including the heat seal layer (A) as a surface layer is compensated for and problems such as film elongation during the production of the layered film are prevented from occurring, thereby enabling the assurance of productivity and the enhancement of the hardness as a lid material film. Thus, it is possible to enhance the 180° peel strength of various containers.

The 1% secant modulus of the base material layer (B) is 250 MPa or more, preferably 265 MPa or more, and more preferably 280 MPa or more. The upper limit is not particularly limited but is preferably 1100 MPa or less. When the resin layer has a 1% secant modulus of less than 250 MPa or when the base material layer (B) is not layered, the 180° peel strength of various containers is deteriorated, causing the deterioration of adhesion. Thus, the pressure resistance is harmed in spite of the sealable resin layer including the heat seal layer (A) as a surface layer being a soft resin layer, and even during a manufacturing step of the sealant film, the film, due to its softness, results in, for example, its winding around a roll and in film elongation, through which the deterioration of film stability occurs. Accordingly, this is not preferable.

As the resin contained in the base material layer (B), an ethylene resin is preferably a main resin component, and relative to the resin component contained in the base material layer (B), preferably 50% by mass or more is an ethylene resin, more preferably 60% to 100% by mass is an ethylene resin, and even more preferably 75% to 100% by mass is an ethylene resin. The ethylene resin may be formed of a single ethylene resin or may be used as a combination of a plurality of ethylene resins having different densities and MFRs. Examples include low-density polyethylene (LDPE), medium-density polyethylene (MDPE), high-density polyethylene (HDPE), and linear low-density polyethylene (LLDPE). Among these, ethylene resins having a density of 0.925 g to 0.960 g/cm³ are preferable, medium-density to high-density polyethylene having a density of 0.925 g to 0.960 g/cm³ is more preferable, and medium-density polyethylene having a density of 0.925 g to 0.940 g/cm³ is particularly preferable, because these facilitate the adjustment of the 1% secant modulus of the base material layer (B) to 250 MPa or more. These are more preferably non-rubbery olefin resins.

A resin component other than the foregoing may be contained in the base material layer (B) within the range that does not impair the advantageous effects of the present invention. As such a resin component other than the foregoing, for example, a polyolefin resin other than the foregoing can be used, and the content of the resin other than the foregoing is preferably 10% by mass or less and more preferably 5% by mass or less relative to the resin component contained in the base material layer (B).

### [Method for Manufacturing Sealant Film]

A method for manufacturing the sealant film having easy-openability according to the present invention is not particularly limited. However, an example is a method in which individual resins or resin mixtures used for individual layers are separately heat melted with different extruders, and in a melt state, the heat seal layer (A), the middle layer (C1), the middle layer (C2), and the base material layer (B) are layered by a method such as a coextrusion multilayer dice method or a feed block method to be thereafter molded into film form and coextruded by, for example, inflation or a T-die/chill roll method. A coextrusion method is preferable because it enables the thickness proportion of individual layers to be relatively freely adjusted and contributes to the obtainment of a layered film excellent in hygiene and cost performance. When, for example, resins having the large temperature difference between the melting point and the glass transition point are layered, during coextrusion processing, the film appearance can be deteriorated or the difficulties in uniform layer structure formation can be caused. To prevent or reduce such deterioration, a T-die/chill roll method capable of performing melt extrusion at a relatively high temperature is preferable.

In the sealant film according to the present invention, the base material layer (B) is preferably subjected to surface treatment for the purpose of enhancing printability and laminatability. Examples of the surface treatment include surface oxidation treatment such as corona treatment, plasma treatment, chromic acid treatment, flame treatment, hot air treatment, or ozone-ultraviolet light treatment; or surface roughening treatment such as sandblasting, but corona treatment is preferable. Furthermore, for the impartation of film processability functions, for example, appropriately, a lubricant, an antiblocking agent, an ultraviolet light absorber, a photostabilizer, an antistatic agent, or a conductive agent may be added or coating with these may be performed. As these additives or coating agents, various additives or coating agents for olefin resins are preferably used.

### [Laminate Film]

The sealant film according to the present invention is desirably laminated together with an oriented base material film because this generally enables, for example, the assurance of strength great enough to prevent fracture, the assurance of heat resistance during heat sealing, and the enhancement of print designability. Examples of the oriented base material film to be laminated include, biaxially oriented polyester films, biaxially oriented nylon films, and biaxially oriented polypropylene films, but biaxially oriented polyester films are more preferable in view of, for example, fracture strength and transparency. As needed, the oriented base material film may be subjected to easy-tear processing or antistatic treatment. The method for laminating the sealant film and the oriented base material film together is not particularly limited, but the use of a combination technique such as dry lamination, extrusion lamination, heat lamination, or multilayer extrusion coating is sufficient. Examples of an adhesive used when the sealant film and the oriented base material film are laminated together by a dry lamentation method include polyether-polyurethane adhesives and polyester-polyurethane adhesives.

### EXAMPLES

Hereafter, the present invention will be specifically described with reference to Synthesis Examples, Examples, and Comparative Examples, but these are not intended to limit the present invention. The “parts” and the “%” in the examples are all on the weight basis.

<Manufacture of Resin Compositions for Sealable Resin Layer>

### Synthesis Example 1

An ethylene-vinyl acetate copolymer resin having a vinyl acetate-derived component content of 30% and a MFR of 3.0 g/10 min (which is hereafter abbreviated as “EVA1”) and a cyclic aliphatic petroleum resin (“ARKON P-100” manufactured by Arakawa Chemical Industries, Ltd. which is hereafter abbreviated as “petroleum resin 1”) were used in a (mass) ratio of EVA1/petroleum resin 1=85/15, and with respect to the sum of these, erucic acid amide (antiblocking agent) and a synthetic zeolite having an average particle size of 3 μm were mixed such that the erucic acid amide was 2000 ppm and the synthetic zeolite was 5000 ppm. The mixture was melt kneaded with a single-screw extruder having an opening diameter of 40 mm and thereafter pelletization was performed to thereby obtain pellets of an EVA resin composition 1 for a sealable resin layer.

### Synthesis Example 2

Except that an ethylene-vinyl acetate copolymer resin having a vinyl acetate-derived component content of 25% and a MFR of 3.0 g/10 min (which is hereafter abbreviated as “EVA2”) and a petroleum resin 1 were used in a (mass) ratio of EVA2/petroleum resin 1=85/15, the same method as in Synthesis Example 1 was used to perform pelletization to thereby obtain pellets of an EVA resin composition 2 for a sealable resin layer.

### Synthesis Example 3

Except that an ethylene-vinyl acetate copolymer resin having a vinyl acetate-derived component content of 21% and a MFR of 3.0 g/10 min (which is hereafter abbreviated as “EVA3”) and a petroleum resin 1 were used in a (mass) ratio of EVA3/petroleum resin 1=85/15, the same method as in Synthesis Example 1 was used to perform pelletization to thereby obtain pellets of an EVA resin composition 3 for a sealable resin layer.

### Synthesis Example 4

Except that an ethylene-vinyl acetate copolymer resin having a vinyl acetate-derived component content of 19% and a MFR of 3.0 g/10 min (which is hereafter abbreviated as “EVA4”) and a petroleum resin 1 were used in a (mass) ratio of EVA4/petroleum resin 1=85/15, the same method as in Synthesis Example 1 was used to perform pelletization to thereby obtain pellets of an EVA resin composition 4 for a sealable resin layer.

### Synthesis Example 5

Except that an ethylene-vinyl acetate copolymer resin having a vinyl acetate-derived component content of 15% and a MFR of 3.0 g/10 min (which is hereafter abbreviated as “EVA5”) and a petroleum resin 1 were used in a (mass) ratio of EVA5/petroleum resin 1=85/15, the same method as in Synthesis Example 1 was used to perform pelletization to thereby obtain pellets of an EVA resin composition 5 for a sealable resin layer.

### Synthesis Example 6

Except that an ethylene-vinyl acetate copolymer resin having a vinyl acetate-derived component content of 13% and a MFR of 3.0 g/10 min (which is hereafter abbreviated as “EVA6”) and a petroleum resin 1 were used in a (mass) ratio of EVA6/petroleum resin 1=85/15, the same method as in Synthesis Example 1 was used to perform pelletization to thereby obtain pellets of an EVA resin composition 6 for a sealable resin layer.

### Synthesis Example 7

Except that an ethylene-methyl methacrylate copolymer resin (methyl methacrylate-derived component content: 20%, MFR: 3.0 g/10 min, which is hereafter abbreviated as “EMMA1”) and a petroleum resin 1 were used in a (mass) ratio of EMMA1/petroleum resin 1=85/15, the same method as in Synthesis Example 1 was used to perform pelletization to thereby obtain pellets of an EMMA resin composition 1 for a sealable resin layer.

### Example 1

The EVA resin composition 2 [1% secant modulus: 20 MPa], linear low-density polyethylene [1% secant modulus: 50 MPa] (which is hereafter abbreviated as “PE1”), and a mixture of 75 parts of linear low-density polyethylene and 25 parts of low-density polyethylene [1% secant modulus: 250 MPa] (which is hereafter abbreviated as “PE3”) were respectively used for the heat seal layer (A), the middle layer (C1), and the base material layer (B). The resins were separately supplied to an extruder for the heat seal layer (A), an extruder for the middle layer (C1), and an extruder for the base material layer (B), and by a coextrusion method, extrusion was performed at a T-die temperature of 240° C. such that the thicknesses of the layers (A), (C1), and (B) were 15 μm, 15 μm, and 5 μm, respectively. Cooling was thereafter performed with a water-cooled metal chill roll at 40° C., and corona discharge treatment was performed such that the wetting tension of the base material layer (B) was 40 mN/m. Subsequently, the obtained product was taken up by a roll and was subjected to aging for 24 hours in an aging room at 40° C. to thereby obtain a coextruded layered film having an overall thickness of 35 μm.

### Example 2

Except that the EVA resin composition 3 [1% secant modulus: 32 MPa], PE1, and PE3 were respectively used for the heat seal layer (A), the middle layer (C1), and the base material layer (B), the same method as in Example 1 was used to obtain a coextruded layered film having an overall thickness of 35 μm, with the thicknesses of the layers (A), (C1), and (B) being 15 μm, 15 μm, and 5 μm, respectively.

### Example 3

Except that the EMMA resin composition 1 [1% secant modulus: 35 MPa], PE1, and PE3 were respectively used for the heat seal layer (A), the middle layer (C1), and the base material layer (B), the same method as in Example 1 was used to obtain a coextruded layered film having an overall thickness of 35 μm, with the thicknesses of the layers (A), (C1), and (B) being 15 μm, 15 μm, and 5 μm, respectively.

### Example 4

Except that the EVA resin composition 4 [1% secant modulus: 39 MPa], PE1, and PE3 were respectively used for the heat seal layer (A), the middle layer (C1), and the base material layer (B), the same method as in Example 1 was used to obtain a coextruded layered film having an overall thickness of 35 μm, with the thicknesses of the layers (A), (C1), and (B) being 15 μm, 15 μm, and 5 μm, respectively.

### Example 5

Except that the EVA resin composition 5 [1% secant modulus: 45 MPa], an ethylene-vinyl acetate copolymer resin having a vinyl acetate-derived component content of 19% and a MFR of 3.0 g/10 min [1% secant modulus: 30 MPa] (which is hereafter abbreviated as “EVA7”), PE1, and PE3 were respectively used for the heat seal layer (A), the middle layer (C2), the middle layer (C1), and the base material layer (B), that the resins were separately supplied to the extruder for the heat seal layer (A), an extruder for the middle layer (C2), the extruder for the middle layer (C1), and the extruder for the base material layer (B), and that, by the coextrusion method, extrusion was performed at a T-die temperature of 240° C. such that the thicknesses of the layers (A), (C2), (C1), and (B) were 5 μm, 10 μm, 15 μm, and 5 μm, respectively, the same method as in Example 1 was used to obtain a coextruded layered film having an overall thickness of 35 μm.

### Example 6

Except that the EVA resin composition 5 [1% secant modulus: 45 MPa], PE1, and PE3 were respectively used for the heat seal layer (A), the middle layer (C1), and the base material layer (B), the same method as in Example 1 was used to obtain a coextruded layered film having an overall thickness of 35 μm, with the thicknesses of the layers (A), (C1), and (B) being 15 μm, 15 μm, and 5 μm, respectively.

### Example 7

Except that the EVA resin composition 3 and PE3 were respectively used for the heat seal layer (A) and the base material layer (B), that the resins were separately supplied to the extruder for the heat seal layer (A) and the extruder for the base material layer (B), and that, by the coextrusion method, extrusion was performed at a T-die temperature of 240° C. such that the thicknesses of the layers (A) and (B) were 15 μm and 30 μm, respectively, the same method as in Example 1 was used to obtain a coextruded layered film having an overall thickness of 45 μm.

### Example 8

The same method as in Example 2 was used to obtain a coextruded layered film having an overall thickness of 30 μm, with the thicknesses of the layers (A), (C1), and (B) being 10 μm, 5 μm, and 15 μm, respectively.

### Example 9

The same method as in Example 2 was used to obtain a coextruded layered film having an overall thickness of 53 μm, with the thicknesses of the layers (A), (C1), and (B) being 30 μm, 20 μm, and 3 μm, respectively.

### Example 10

The same method as in Example 2 was used to obtain a coextruded layered film having an overall thickness of 80 μm, with the thicknesses of the layers (A), (C1), and (B) being 30 μm, 20 μm, and 30 μm, respectively.

### Example 11

Except that linear low-density polyethylene [1% secant modulus: 150 MPa] (which is hereafter abbreviated as “PE2”) was used for the middle layer (C1) of Example 2, the same method as in Example 2 was used to obtain a coextruded layered film having an overall thickness of 35 μm, with the thicknesses of the layers (A), (C1), and (B) being 15 μm, 15 μm, and 5 μm, respectively.

### Example 12

Except that high-density polyethylene [1% secant modulus: 900 MPa] (which is hereafter abbreviated as “PE4”) was used for the base material layer (B) of Example 2, the same method as in Example 2 was used to obtain a coextruded layered film having an overall thickness of 31 μm, with the thicknesses of the layers (A), (C1), and (B) being 15 μm, 15 μm, and 1 μm, respectively.

### Comparative Example 1

Except that the EVA resin composition 1 [1% secant modulus: 16 MPa], PE1, and PE3 were respectively used for the heat seal layer (A), the middle layer (C1), and the base material layer (B), the same method as in Example 1 was used to obtain a coextruded layered film having an overall thickness of 35 μm, with the thicknesses of the layers (A), (C1), and (B) being 15 μm, 15 μm, and 5 μm, respectively.

### Comparative Example 2

Except that the EVA resin composition 6 [1% secant modulus: 50 MPa], PE1, and PE3 were respectively used for the heat seal layer (A), the middle layer (C1), and the base material layer (B), the same method as in Example 1 was used to obtain a coextruded layered film having an overall thickness of 35 μm, with the thicknesses of the layers (A), (C1), and (B) being 15 μm, 15 μm, and 5 μm, respectively.

### Comparative Example 3

The same method as in Example 7 was used to obtain a coextruded layered film having an overall thickness of 30 μm, with the thicknesses of the layers (A) and (B) being 10 μm and 20 μm, respectively.

### Comparative Example 4

The same method as in Example 2 was used to obtain a coextruded layered film having an overall thickness of 65 μm, with the thicknesses of the layers (A), (C1), and (B) being 30 μm, 30 μm, and 5 μm, respectively.

### Comparative Example 5

Except that PE3 was used for the middle layer (C1) of Example 2, the same method as in Example 2 was used to obtain a coextruded layered film having an overall thickness of 35 μm, with the thicknesses of the layers (A), (C1), and (B) being 15 μm, 15 μm, and 5 μm, respectively.

### Comparative Example 6

Except that the EVA resin composition 3 and PE1 were respectively used for the heat seal layer (A) and the middle layer (C1), the same method as in Example 1 was used to obtain a coextruded layered film having an overall thickness of 15 μm, with the thicknesses of the layers (A) and (C1) being 10 μm and 5 μm, respectively.

### Comparative Example 7

Except that the EVA resin composition 3 and PE3 were respectively used for the heat seal layer (A) and the base material layer (B), the same method as in Example 1 was used to obtain a coextruded layered film having an overall thickness of 80 μm, with the thicknesses of the layers (A) and (B) being 40 μm and 40 μm, respectively.

The following evaluation was performed on, for example, each of the layered films obtained in Examples and Comparative Examples. The results obtained are as presented in Tables below.

### [Measurement of 1% Secant Modulus]

Films having a thickness of 30 μm that had been cut to a size of 300 mm in length×25.4 mm in width (gauge interval: 200 mm) such that the longitudinal direction had aligned with the flow direction (length direction) of the films were used as test specimens to perform the measurement of the 1% secant modulus under the condition of a tensile speed of 20 mm/min in accordance with ASTM D-882. The films having a thickness of 30 μm used for the measurement of the 1% secant modulus were films having a thickness of 30 μm that had been separately formed of the resins having the same compositions as those of the resin layers, namely, the heat seal layer (A), the middle layer (C2), the middle layer (C1), and the base material layer (B) using extruders of a film manufacturing apparatus that included the extruders with a T-die therefor; and a water-cooled metal chill roll, left to stand at 40° C. for 48 hours to be subjected to aging, and thereafter left to stand under the measurement condition of 23° C. for 24 hours.

### [Method for Producing Laminate Film]

A biaxially oriented polyethylene terephthalate (PET) film (thickness: 12 μm) was bonded to a surface of the base material layer (B) of each of the coextruded multilayer films obtained in the above-described Examples and Comparative Examples by dry lamination and thereafter aging was performed at 40° C. for 36 hours to obtain a laminate film. Here, a two-liquid curable adhesive (a polyester adhesive “DIC DRY LX 500” and curing agent “KW 75”) manufactured by DIC Corporation was used as an adhesive for dry lamination.

### [Method for Measuring Heat Seal Strength]

A surface of the heat seal layer (A) of each laminate film obtained and an A-PET sheet (100 μm) were stacked together, under the conditions of a heat seal temperature of 170° C., a sealing pressure of 0.2 MPa, and a sealing time of 1 second. Subsequently, the heat sealed film was naturally cooled at 23° C. for 24 hours and thereafter cut into a strip having a width of 15 mm, and this served as a test specimen. In a thermostatic chamber at 23° C. and 50% RH, 180° peeling was performed on the test specimen at a speed of 300 mm/min using a tensile tester (manufactured by A&D Co., Ltd.) to thereby measure the heat seal strength.

### [Evaluation of Heat Sealability]

On the basis of the results of the heat seal strength measured as described above, the heat sealability to the A-PET sheet was evaluated by the following criteria.

Good: The heat seal strength is 13 N/15 mm or more.

Poor: The heat seal strength is less than 13 N/15 mm.

### [Method for Measuring Burst Strength]

Each laminate film obtained was cut to a size of 10 cm×10 cm and was stacked on an A-PET 88 mm-rectangular molded container (depth: 22 mm) such that a surface of the heat seal layer (A) was positioned on the flange side of the container. Using a cup sealer (a cup sealer manufactured by Shinwa Kikai Co., Ltd.), these were thereafter heat sealed with an upper heat seal mold adjusted to a temperature of 170° C. under the conditions of a sealing pressure of about 65 Kg and a sealing time of 1 second. Subsequently, in accordance with “8. Burst strength tests for containers” in JIS Z 0238: 1998 [“Methods for testing heat sealed flexible packaging bags and semi-rigid containers”], the test sample container was placed on a horizontal plane, a rubber sheet having a thickness of about 1 mm was fixed to a lid portion of the test sample container, and an air needle was inserted into this rubber sheet portion to thereby send air from a testing apparatus into the test sample container in an amount of 1.0±0.2 L/min. The sending of air was continued until the container was burst, and the maximum pressure when the container was burst was measured and determined to be the burst strength.

### [Evaluation of Pressure Resistance]

On the basis of the results of the burst strength measured as described above, the pressure resistance was evaluated by the following criteria.

Good: The burst strength is 30 KPa or more.

Poor: The burst strength is less than 30 KPa.

### [Method for Evaluating Openability]

The same procedure as in the above-described method for measuring the burst strength was used to produce a test sample container in which each laminate film was heat sealed to an A-PET rectangular molded container. Subsequently, an outer film portion of the heat sealed flange portion of the container was grabbed by hand to thereby evaluate an open state when the lid material was peeled off of the flange horizontal plane at an angle of 45 degrees.

### [Evaluation of Openability]

Good: No poor peeling such as a film residue occurs during opening.

Poor: Poor peeling such as a film residue occurs during opening.

TABLE 1

| Layered film structure | | | | | | | | | | | | | | | | |
|---|---|---|---|---|---|---|---|---|---|---|---|---|---|---|---|---|
| Layer | | Main resin | Modulus | | | | | | | | | | | | | |
| structure | | component | [MPa] | Example 1 | | Example 2 | | Example 3 | | Example 4 | | Example 5 | | Example 6 | | Example 7 |
| Sealable | Heat | EVA resin | 20 | 15 | μm | — | | — | | — | | — | | — | | — |
| resin | seal | composition 2 | | | | | | | | | | | | | | |
| layer | layer | EVA resin | 32 | — | | 15 | μm | — | | — | | — | | — | | 15 μm |
| | (A) | composition 3 | | | | | | | | | | | | | | |
| | | EVA resin | 39 | — | | — | | — | | 15 | μm | — | | — | | — |
| | | composition 4 | | | | | | | | | | | | | | |
| | | EVA resin | 45 | — | | — | | — | | — | | 5 | μm | 15 | μm | — |
| | | composition 5 | | | | | | | | | | | | | | |
| | | EMMA resin | 35 | — | | — | | 15 | μm | — | | — | | — | | — |
| | | composition 1 | | | | | | | | | | | | | | |
| | Middle | EVA7 | 30 | — | | — | | — | | — | | 10 | μm | — | | — |
| | layer | | | | | | | | | | | | | | | |
| | (C2) | | | | | | | | | | | | | | | |
| | Middle | PE1 | 50 | 15 | μm | 15 | μm | 15 | μm | 15 | μm | 15 | μm | 15 | μm | — |

| | | | | | | | | | |
|---|---|---|---|---|---|---|---|---|---|
| layer | PE2 | 150 | — | — | — | — | — | — | — |
| (C1) | | | | | | | | | |

| | | | | | | | | | | | | | | | |
|---|---|---|---|---|---|---|---|---|---|---|---|---|---|---|---|
| Base | PE3 | 250 | 5 | μm | 5 | μm | 5 | μm | 5 | μm | 5 | μm | 5 | μm | 30 μm |

| | | | | | | | | | |
|---|---|---|---|---|---|---|---|---|---|
| material | PE4 | 900 | — | — | — | — | — | — | — |
| layer (B) | | | | | | | | | |

| | | | | | | | | |
|---|---|---|---|---|---|---|---|---|
| Film | Heat sealability | Good | Good | Good | Good | Good | Good | Good |
| evaluation | Pressure resistance | Good | Good | Good | Good | Good | Good | Good |
| | Openability | Good | Good | Good | Good | Good | Good | Good |

| Layered film structure | | | | | | | | | | | | |
|---|---|---|---|---|---|---|---|---|---|---|---|---|
| Layer | | Main resin | Modulus | | | | | | | | | |
| structure | | component | [MPa] | Example 8 | | Example 9 | | Example 10 | Example 11 | | Example 12 | |
| Sealable | Heat | EVA resin | 20 | — | | — | | — | — | | — | |
| resin | seal | composition 2 | | | | | | | | | | |
| layer | layer | EVA resin | 32 | 10 | μm | 30 | μm | 30 μm | 15 | μm | 15 | μm |
| | (A) | composition 3 | | | | | | | | | | |

| | EVA resin | 39 | — | | — | | — | — | — | |
|---|---|---|---|---|---|---|---|---|---|---|
| | composition 4 | | | | | | | | | |
| | EVA resin | 45 | — | | — | | — | — | — | |
| | composition 5 | | | | | | | | | |
| | EMMA resin | 35 | — | | — | | — | — | — | |
| | composition 1 | | | | | | | | | |
| Middle | EVA7 | 30 | — | | — | | — | — | — | |
| layer | | | | | | | | | | |
| (C2) | | | | | | | | | | |
| Middle | PE1 | 50 | 5 | μm | 20 | μm | 20 μm | — | 15 | μm |

| | | | | | | | | |
|---|---|---|---|---|---|---|---|---|
| layer | PE2 | 150 | — | — | — | 15 | μm | — |
| (C1) | | | | | | | | |

| | | | | | | | | | | |
|---|---|---|---|---|---|---|---|---|---|---|
| Base | PE3 | 250 | 15 | μm | 3 | μm | 30 μm | 5 | μm | — |

| | | | | | | | | |
|---|---|---|---|---|---|---|---|---|
| material | PE4 | 900 | — | — | — | — | 1 | μm |
| layer (B) | | | | | | | | |

| | | | | | | |
|---|---|---|---|---|---|---|
| Film | Heat sealability | Good | Good | Good | Good | Good |
| evaluation | Pressure resistance | Good | Good | Good | Good | Good |
| | Openability | Good | Good | Good | Good | Good |

TABLE 2

| Layered film structure | | | | | | | | | | | |
|---|---|---|---|---|---|---|---|---|---|---|---|
| Layer | | Main resin | Modulus | Comparative | | Comparative | Comparative | Comparative | Comparative | Comparative | Comparative |
| structure | | component | [MPa] | Example 1 | | Example 2 | Example 3 | Example 4 | Example 5 | Example 6 | Example 7 |
| Sealable | Heat | EVA resin | 16 | 15 | μm | — | — | — | — | — | — |
| resin | seal | composition 1 | | | | | | | | | |

| | | | | | | | | | | | | | |
|---|---|---|---|---|---|---|---|---|---|---|---|---|---|
| layer | layer | EVA resin | 32 | — | — | 10 μm | 30 | μm | 15 | μm | 10 | μm | 40 μm |
| | (A) | composition 3 | | | | | | | | | | | |

| | EVA resin | 50 | — | | 15 | μm | — | — | | — | — | | — |
|---|---|---|---|---|---|---|---|---|---|---|---|---|---|
| | composition 6 | | | | | | | | | | | | |
| Middle | PE1 | 50 | 15 | μm | 15 | μm | — | 30 | μm | — | 5 | μm | — |

| | | | | | | | | | | |
|---|---|---|---|---|---|---|---|---|---|---|
| layer | PE3 | 250 | — | — | — | — | 15 | μm | — | — |
| (C1) | | | | | | | | | | |

| | | | | | | | | | | | | | |
|---|---|---|---|---|---|---|---|---|---|---|---|---|---|
| Base | PE3 | 250 | 5 | μm | 5 | μm | 20 μm | 5 | μm | 5 | μm | — | 40 μm |
| material | | | | | | | | | | | | | |
| layer | | | | | | | | | | | | | |

| | | | | | | | | |
|---|---|---|---|---|---|---|---|---|
| Film | Heat sealability | Poor | Good | Good | Poor | Good | Poor | Good |
| evaluation | Pressure resistance | Good | Poor | Poor | Poor | Poor | Poor | Poor |
| | Openability | Poor | Good | Good | Good | Good | Poor | Good |

As evident in the Tables above, the laminate films formed of the layered films of Examples 1 to 12 according to the present invention, not only exhibit good heat sealability and pressure resistance but also have easy-openability and thus are suitable for applications such as lid materials of packaging containers. On the other hand, those of Comparative Examples 1 to 7 failed to achieve suitable heat sealability, pressure resistance, and easy-openability.

1. A sealant film comprising a layered film that includes a sealable resin layer including a heat seal layer (A) as a surface layer; and a base material layer (B), wherein
the sealable resin layer is formed of a resin layer having a 1% secant modulus of 200 MPa or less and has a thickness of 15 μm to 50 μm,
the heat seal layer (A) has a 1% secant modulus of 20 MPa to 45 MPa and a thickness of 5 μm or more, and
the base material layer (B) has a 1% secant modulus of 250 MPa or more and a thickness of 1 μm to 30 μm.

2. The sealant film according to claim 1, wherein the heat seal layer (A) is a layer having an ethylene resin as a main resin component.

3. The sealant film according to claim 2, wherein the ethylene resin contains an ethylene-vinyl acetate copolymer or an ethylene-methyl methacrylate copolymer.

4. The sealant film according to claim 1, wherein the sealable resin layer is a layer including the heat seal layer (A).

5. The sealant film according to claim 1, wherein the sealable resin layer is a layer including the heat seal layer (A); and a middle layer (C1) having a 1% secant modulus of 50 MPa to 150 MPa.

6. The sealant film according to claim 5, wherein the middle layer (C1) is a resin layer having an ethylene resin as a main resin component and has a thickness of 5 μm to 20 μm.

7. The sealant film according to claim 1, wherein the sealable resin layer is a layer in which the heat seal layer (A), a middle layer (C1) having a 1% secant modulus of 50 MPa to 150 MPa, and a middle layer (C2) having a 1% secant modulus of 20 MPa to 60 MPa are layered in an order of (A)/(C2)/(C1).

8. The sealant film according to claim 7, wherein the middle layer (C1) and the middle layer (C2) are resin layers having an ethylene resin as a main resin component, the middle layer (C1) has a thickness of 5 μm to 20 μm, and the middle layer (C2) has a thickness of 5 μm to 20 μm.

9. The sealant film according to claim 1, wherein the base material layer (B) is a resin layer having an ethylene resin as a main resin component.

10. A layered film comprising the sealant film according to claim 1, wherein a base material is laminated to the base material layer (B) of the sealant film.

11. A packaging material comprising the layered film according to claim 10.

12. The packaging material according to claim 11, wherein the packaging material is applied to high-pressure treatment.
